(19) United States
(12) Patent Application Publication
(10) Pub. No.: US 2025/0339332 A1
(43) Pub. Date: Nov. 6, 2025

(54) WARNING DOME DEVICE AND MANUFACTURE METHOD THEREOF

(71) Applicants: Sydney D Chase, Glendora, CA (US); Larry Harden, Glendora, CA (US); Rolance Mehserdjian, Glendora, CA (US)

(72) Inventors: Sydney D Chase, Glendora, CA (US); Larry Harden, Glendora, CA (US); Rolance Mehserdjian, Glendora, CA (US)

(21) Appl. No.: 19/265,986

(22) Filed: Jul. 10, 2025

Related U.S. Application Data
(63) Continuation of application No. 18/528,625, filed on Dec. 4, 2023, now Pat. No. 12,370,119.

(51) Int. Cl. A61H 3/06; B28B 1/14; B28B 7/00

(52) U.S. Cl. CPC A61H 3/066; B28B 1/14; B28B 7/0064; A61H 2201/169

(57) ABSTRACT

A patterned warning mat according to the present disclosure having a base and a plurality of domes and patterns formed on the base. The warning mat is obtained by a process comprising the steps of providing an open-face mold having a plurality of textures and a plurality of dome indentations, preparing a liquid mixture capable of solidifying, pouring the mixture over the open-face mold, and allowing the mixture to solidify and form the warning mat. The domes and patterns on the warning mat respectively correspond to the dome indentations and textures of the open-face mold.

### CROSS-REFERENCE TO RELATED APPLICATIONS

This application is a continuation of and incorporates by reference U.S. Non Provisional Application 18/528,625 filed on Dec. 4, 2023.

### FIELD OF THE INVENTION

The present disclosure generally relates to tactile warning dome devices, and specifically to shapes, materials, and methods of manufacture of such devices.

### BACKGROUND OF THE INVENTION

The American's With Disabilities Act, Chapter Seven, Communication Elements and Features, sections 705.1.1, 705.1.2 and 705.1.3 define the truncated dome size, dome spacing and contrast requirements for the design and installation of a tactile and visual warning system to aid visually impaired individuals in the location of edge of pavement/sidewalk transitions. Section 705.2 defines the surface section and location(s) where the tactile warning system is to be installed. This invention provides for the correct truncated dome size, spacing and contrast requirements of the Act as well as providing for an accurate means of locating the truncated domes as prescribed.

A pedestrian with visual impairment may feel a safety dome pattern with their feet (or may even hear the sound of the safety domes if they are driving) thereby alerting them that they entering an area of potential danger, areas such as intersections, crosswalks, highway center lanes, danger zones, sidewalks, walkways, platforms, public transit stations, etc., and is a safety dome invention whereby any person and especially for the sight impaired pedestrians will be made aware of the locations of potential hazards. Pedestrians that have some type of disability need to have a warning system in place to alert them of the potential danger.

There is a need in public transit facilities and streets for pedestrians to be able to detect the locations of potential hazards. By making the pedestrian aware of a potential hazard, safety domes allow the pedestrian or driver to avoid the hazard. The hazardous areas could include sidewalks, curb ramps, crosswalks, stairways, railroad crossings, subways platforms, loading docks, stages, bus loading platforms, man holes, potholes, construction area dangers, road edge warnings, intersections, highways center lanes, etc.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 illustrates a perspective view of an open-face mold according to one embodiment of the present invention;

FIG. 2 is an enlarged view of the open-face mold according to one embodiment of the present invention;

FIG. 3 is a perspective view of the mesh layer with liquid mixture poured thereon, according to one embodiment of the present invention;

FIG. 4 is a perspective view of the mesh layer with colored liquid mixture poured thereon, according to one embodiment of the present invention;

FIG. 5-6 are perspective view and enlarged view of the textured warning mat according to one embodiment of the present invention; and

FIG. 7 is a flow chart of a method of manufacturing a textured warning mat according to one embodiment of the present embodiment.

FIG. 8 is a front view and cross sectional views of the textured warning mat according to one embodiment of the present invention.

FIG. 9 is a flow chart of the method of manufacturing a patterned warning mat according to one embodiment of the present disclosure.

FIG. 10 is a flow chart of the method of manufacturing a patterned warning mat according to another embodiment of the present disclosure.

### DETAILED DESCRIPTION

The embodiment and various embodiments can now be better understood by turning to the following detailed description of the embodiments, which are presented as illustrated examples of the embodiment defined in the claims. It is expressly understood that the embodiment as defined by the claims may be broader than the illustrated embodiments described below. Many alterations and modifications may be made by those having ordinary skill in the art without departing from the spirit and scope of the embodiments.

The present disclosure relates to a textured warning mat having domes and configured to be placed on walkways, crosswalks, and other areas of pedestrian traffic for providing direction and warning to visually handicapped persons. The present disclosure also relates to a method of manufacturing said textured warning dome mat.

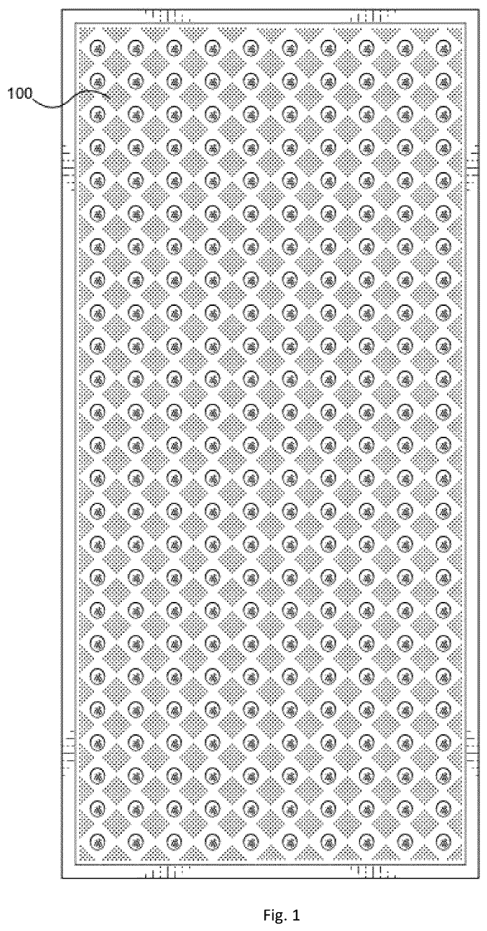

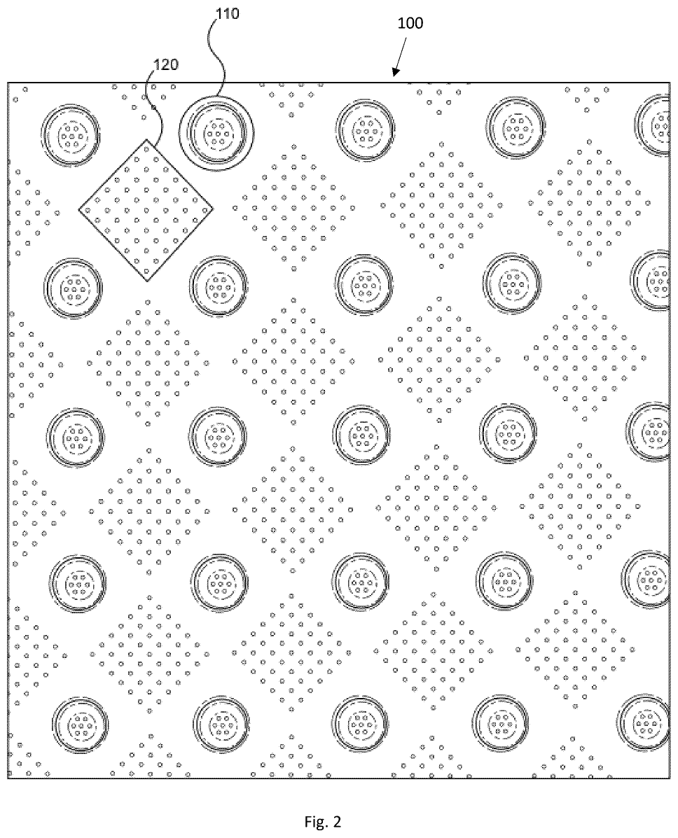

FIG. 1 illustrates a perspective view of an open-face mold 100 according to one embodiment of the present invention. FIG. 2 is an enlarged view of the open-face mold 100. As illustrated in FIGS. 1 and 2, the open-face mold 100 includes a first textures 110 and a second textures 120 distributed over the surface of the open-face mold 100. The purpose of the first textures 110 and second textures 120 is to accommodate liquid mixture poured over the open-face mold 100, so that once the liquid mixture solidifies its surface will have patterns corresponding to the shapes of the first patterns 110 and the second patterns 120.

The first texture 110 of the present embodiment is a sunken half-sphere space with a plurality of tiny openings in the middle. In the present embodiment, the first texture 110 is formed by first drilling a few openings on a metal sheet and then pressing or punching on the metal sheet to form the sunken half-sphere space. However, in different embodiments, the first texture 110 can be formed as part of a plastic open-face mold made using injection open-face molding method or other plastic open-face molding methods. On the other hand, the second texture 120 of the present embodiment is formed by a plurality of tiny openings distributed in substantially a diamond shape. The second texture 120 can be formed by drilling specific number of openings in a diamond shape. In other embodiments, the second pattern can be formed as part of a plastic open-face mold using injection open-face molding method or other plastic open-face molding methods.

Further, as illustrated in FIG. 2, the second texture 120 is located between four adjacent first patterns 110. Similarly, the first texture 110 is located between four adjacent second textures 120.

Further, in the present embodiment, the open-face mold 100 is made of metal. However, in different embodiments, the open-face mold can be made of plastics using injection open-face molding method or other suitable method to have the shape and texture illustrated in FIGS. 1 and 2.

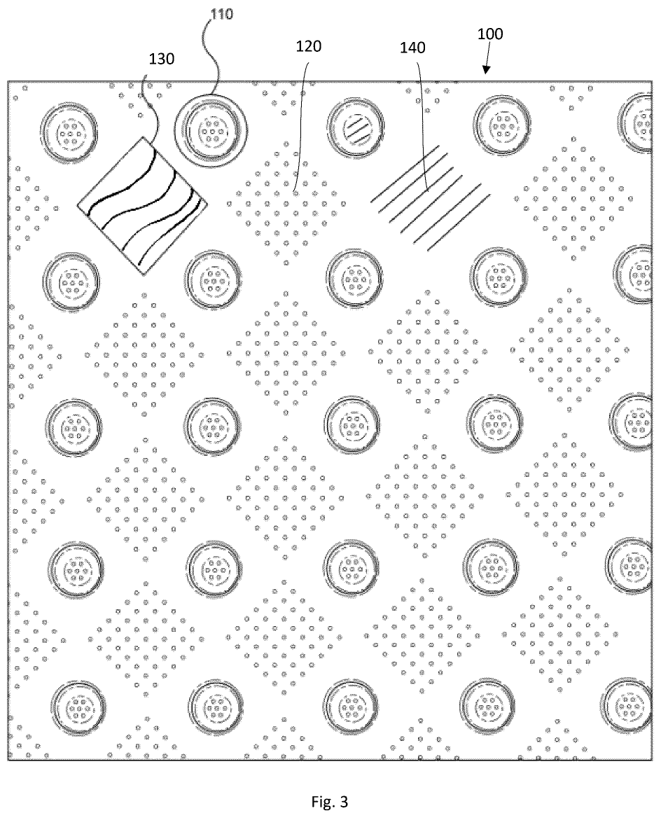

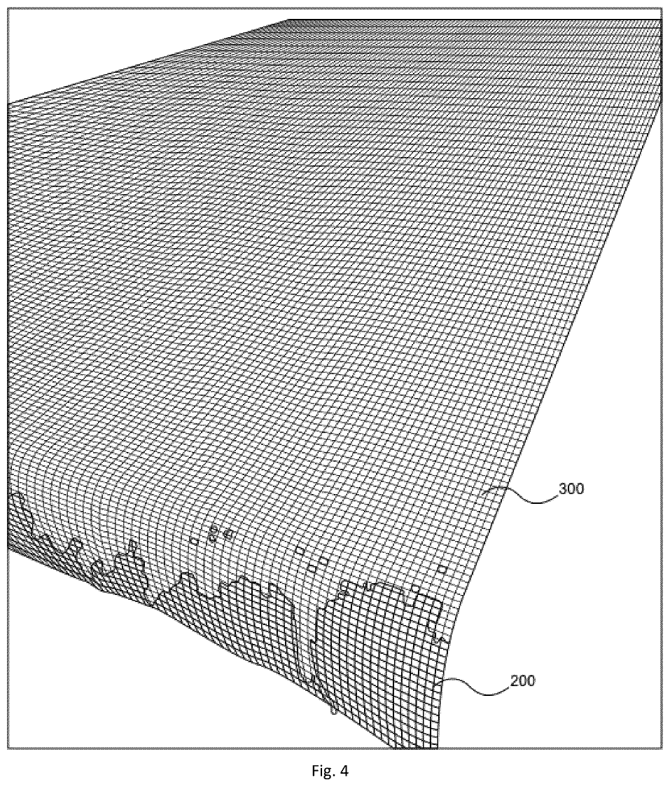

FIGS. 3-4 are perspective views of the mesh layer with liquid mixture poured thereon. As illustrated in FIGS. 3-4, the mesh layer 200 is a flexible and porous screen having a plurality of pores. In the present embodiment, a liquid mixture 300 is first poured over the open-face mold to subsequently accumulate in the textures 110, 120 on the open-face mold 100. However, before the mixture solidifies, the mesh layer 200 is laid over both the open-face mold 100 and the mixture 300. At this moment, the mixture 300 is still in the liquid state and thus will pass through the pores of the mesh layer 200 to immerse the mesh layer 200 in the process. Tools such as float or margin trowel can be used to evenly distribute and smooth the mixture over the open-face mold 100 and the mesh layer 200 before the mixture solidifies. Also, the area of the mesh layer 200 is preferably greater than that of the open-face mold 100, to ensure that the entire area of the open-face mold 100 is fully covered by the mesh layer 200.

The liquid mixture 300 is then allowed to solidify to eventually form a textured warning mat. The part of liquid mixture 300 that occupies the first patterns 110 of the open-face mold 100 solidifies to have shape corresponding to the first patterns 110. Similarly, the part of liquid mixture 300 that occupies the second patterns 120 of the open-face mold 100 solidifies to have shape corresponding to the second patterns 120. Further, the part of liquid mixture 300 that fills the pores of the mesh layer 200 eventually solidifies and form a thin base that preferably contains the mesh layer 200. In other words, the mesh layer 200 is preferably embedded within the cured liquid mixture 300. The solidification process preferably takes 5 to 10 minutes for the liquid mixture 300 to dry up and form the warning mat. However, in different embodiments, the process may take longer or less time depending on the ingredients used to create the liquid mixture 300.

In another embodiment, before a liquid mixture is poured over the open-face mold 100, the mesh layer 200 is first laid over the open-face mold 100 (not illustrated in FIGS. 3-4). Once the open-face mold 100 is at least substantially covered by the mesh layer 200, a liquid mixture 300 is poured over at least the part of the mesh layer 200 above the open-face mold 100. Part of the liquid mixture 300 will pass through the pores of the mesh layer 200 and then accumulate in the first patterns 110 and the second patterns 120 of the open-face mold 100. The liquid mixture 300 eventually immerse the mesh layer 200. Tools such as float or margin trowel can be used to evenly distribute and smooth the mixture over the open-face mold 100 and the mesh layer 200 before the mixture solidifies.

The liquid mixture 300 is then allowed to solidify to eventually form a textured warning mat. The portion of liquid mixture 300 that occupies the first patterns 110 of the open-face mold 100 solidifies to have shape corresponding to the first patterns 110. Similarly, the portion of liquid mixture 300 that occupies the second patterns 120 of the open-face mold 100 solidifies to have shape corresponding to the second patterns 120. Further, the part of liquid mixture 300 also forms a thin base that preferably contains or immerse the mesh layer 200. In other words, the mesh layer 200 is immersed and embedded within the cured liquid mixture 300. The solidification process preferably takes 5 to 10 minutes for the liquid mixture 300 to dry up (or cool down) and form the warning mat. However, in different embodiments, the process may take longer or less time depending on the ingredients used to create the liquid mixture 300.

The liquid mixture 300 of the present embodiment includes cement, resin, and bonding agents (such as clay and water, oil, and sodium silicate), but is not limited thereto. In different embodiments, the liquid mixture 300 can also include glass and sand as well as other materials such as common mineral fillers, glass beads, skid resistant material, and color pigments.

In the embodiment illustrated in FIGS. 3-4, the liquid mixture 300 does not contain color pigments. To add color, the cured liquid mixture 300 is removed from the open-face mold 100 and then colored/painted with the desired color pigments. However, in other embodiments such as the one illustrated in FIGS. 3-4, color pigments can be added to the liquid mixture 300 to eliminate the step of painting the liquid mixture 300 after removal from the open-face mold 100. Also, the mixture can be a polymer mixture or an acrylic mixture, depending on the materials used to make the liquid mixture 300.

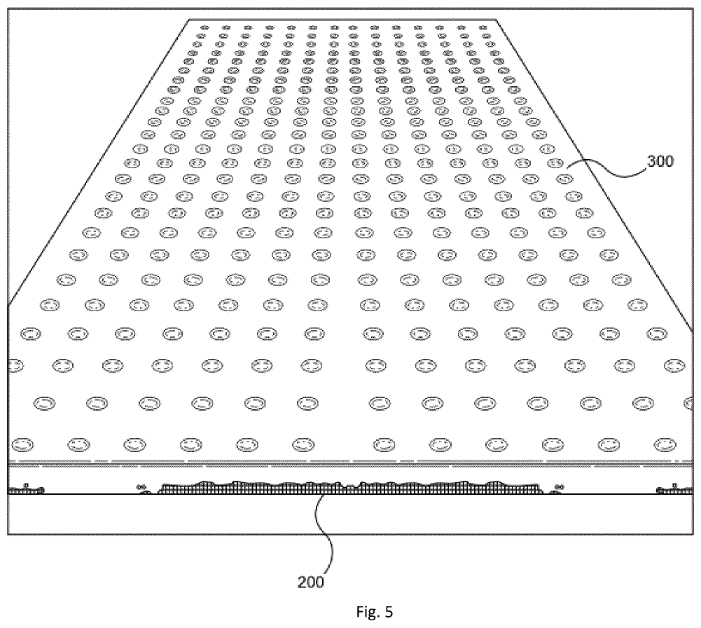

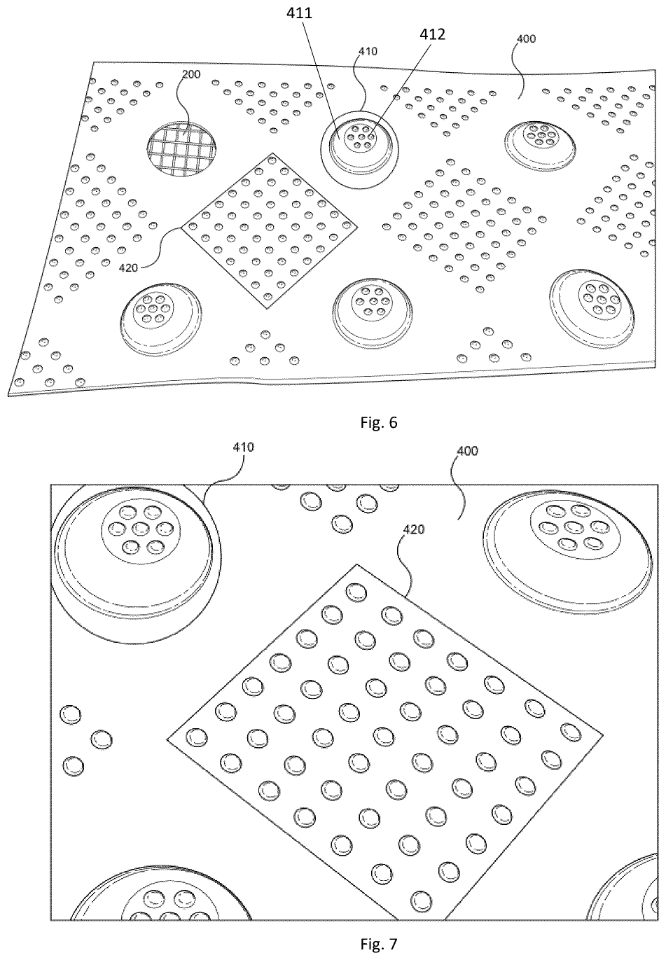

FIGS. 5-6 are respectively a perspective view and an enlarged of the textured warning mat according to one embodiment of the present disclosure. As illustrated in FIGS. 5-6, the warning mat includes a base 400, a first pattern 410, and a second pattern 420. The shape of the first pattern 410 substantially corresponds to that of the first texture 110 of the open-face mold 100 illustrated in FIGS. 1-2. Similarly, the shape of the second pattern 420 substantially corresponds to that of the second texture 120 of the open-face mold 100 illustrated in FIGS. 1-2. The first pattern 410 includes a dome structure 411 and a plurality of protrusions 412 on the dome structure 411. The dome structure 411 and protrusions 412 are both configured to provide auditory and tactile underfoot feedback for the visually impaired. In addition, the protrusions 412 are designed to increase the friction between the pedestrian's shoe and the warning mat to make the warning mat more skid-resistant.

As illustrated in FIG. 5, one of the first pattern 410 is removed to reveal the mesh layer 200 within the base 400. The mesh layer 200 gives flexibility to the warning mat so that it can be laid over uneven surface. Further, the attachment between the cured liquid mixture 300 and the mesh layer 200 also maintains the integrity of the warning mat and keeps the warning mat from breaking down due to external forces.

In the embodiment illustrated in FIGS. 5-6, the warning mat has a first surface 400 and a second surface (not illustrated) on the two opposite sides of the base 400. The first surface 400 is disposed with the first patterns 410 and the second patterns 420 and is the surface to physically interact with the pedestrians. On the other hand, the second surface is the one adhered to the road using adhesives. In one embodiment, the adhesive is water-based acrylic adhesives. However, in different embodiments, rubber/resin adhesives, thermosetting rubber/resin adhesives, precured rubber/resin adhesives, solvent based adhesives, silicone adhesives, heat activated adhesives, thermal release adhesives, electrically conductive/anti-static adhesives, thermally conductive adhesives, or other suitable adhesives can be used to stick the textured warning mat of the present disclosure to wood, asphalt, and concrete.

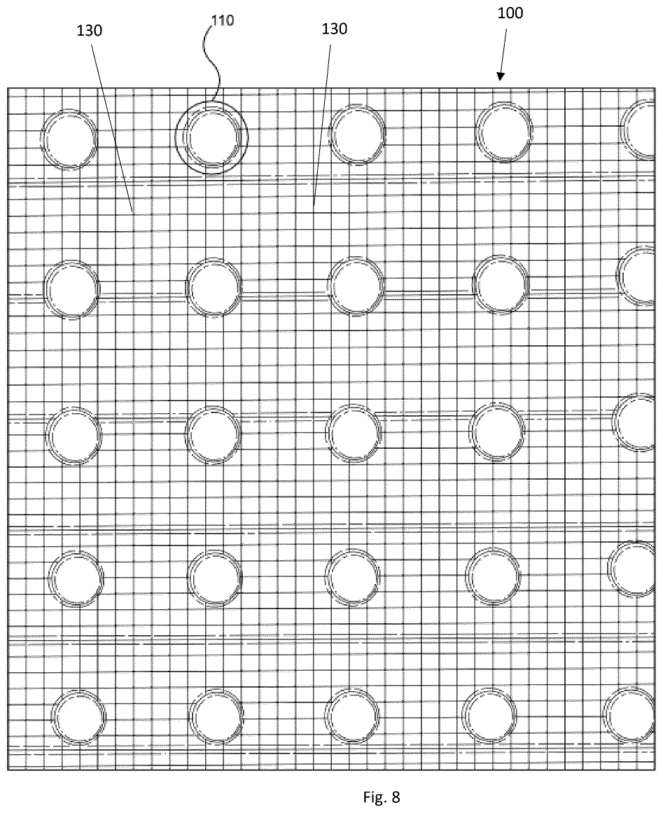

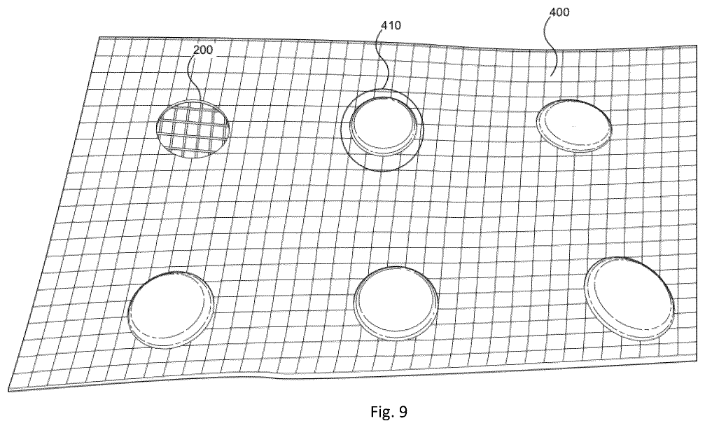

FIG. 7 is a top view of the open-face mold 100 according to a second embodiment of the present disclosure. FIG. 8 is a partial perspective view of the warning mat according to the second embodiment of the present disclosure. The open-face mold 100 of the present embodiment also includes a plurality of first textures 110 similar to the ones illustrated in FIG. 2. The open-face mold 100 also includes a plurality of third textures 130 distributed on the surface of the open-face mold 100. In the present embodiment, the third textures 130 are line grooves that cross one another.

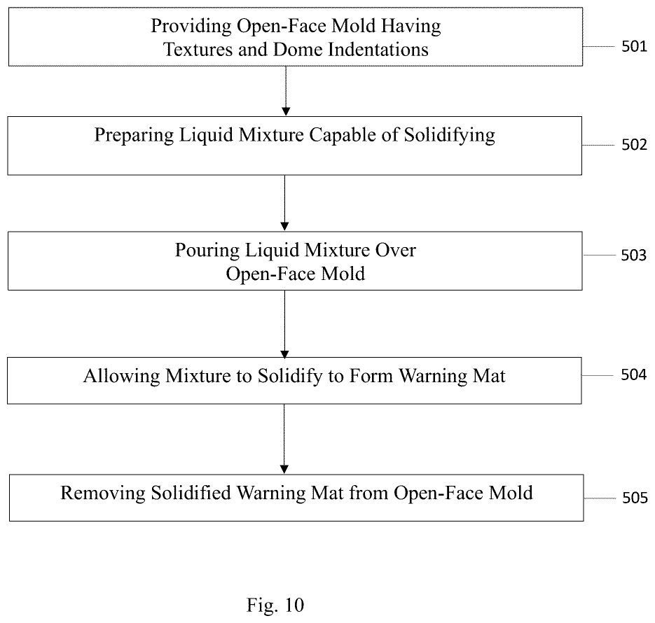

FIG. 9 is a flow chart of the method of manufacturing a patterned warning mat configured to be placed on walkways, crosswalks, and other areas of pedestrian traffic for providing direction and warning to visually handicapped persons, according to one embodiment of the present disclosure. The method includes step 501 of providing an open-face mold having a plurality of textures and a plurality of dome indentations. In the present embodiment, each of dome indentations has a base diameter of 23 mm (0.9 in) minimum to 36 mm (1.4 in) maximum, a top diameter of 50 percent of the base diameter minimum to 65 percent of the base diameter maximum, and a height of 5 mm (0.2 in). Further, the dome indentations have substantially a center-to-center spacing of 41 mm (1.6 in) minimum and 61 mm (2.4 in) maximum, and a base-to-base spacing of 17 mm (0.65 in) minimum, measured between the most adjacent domes. In other embodiments, the dome indentations can have other sizes or spacing depending on the government regulations on dome size and spacing.

In one embodiment, the textures of the open-face mold includes first textures on the dome indentations and second textures located between four dome indentations. The first and second textures can be openings such as the textures 110, 120 illustrated in FIG. 2. In different embodiments, the textures can be grooves such as the third texture 130 illustrated in FIG. 7 or any other etchings or textures with depth that can be formed on the open-face mold.

The method further includes step 502 of preparing a liquid mixture capable of solidifying and chemical reaction. The liquid mixture of the present embodiment includes cement, resin, and bonding agents (such as clay and water, oil, and sodium silicate), but is not limited thereto. In different embodiments, the liquid mixture can also include glass and sand as well as other materials such as common mineral fillers, glass beads, skid resistant material, and color pigments. Further, the process of mixing the above-mentioned materials may result in chemical reactions that generate heat as a result and causes a temperature of the liquid mixture to be higher than a room temperature.

The method further includes step 503 of pouring the mixture over the open face open-face mold. The mixture, still in a liquid state, accumulates in the textures of the open-face mold.

The method further includes step 504 of allowing the mixture to solidify and form the warning mat. The part of liquid mixture that occupies the patterns of the open-face mold solidifies to have shape corresponding to the patterns of the open-face mold. The solidification process preferably takes 5 to 10 minutes for the liquid mixture to solidify and form the warning mat. However, in different embodiments, the process may take longer or less time depending on the ingredients used to create the liquid mixture the liquid mixture.

After confirming the warning mat is taking shape and the solidification of mixture is complete, the method then executes step 505 of removing the warning mat from the open-face mold. As mentioned above, the liquid mixture that forms the warning mat may or may not include the pigment with desired color. Thus, in one embodiment, step 505 may further include adding desired color to the warning mat using pigment, after removal from the open-face mold.

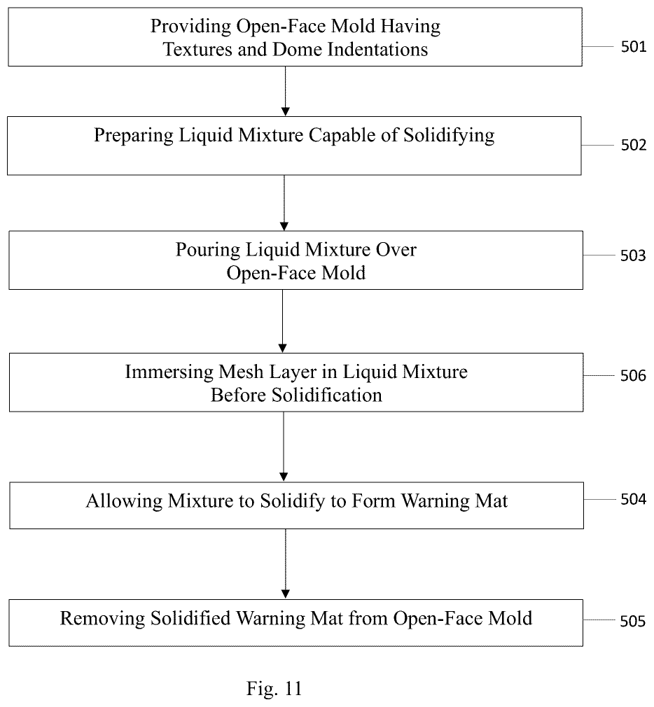

FIG. 10 is a flow chart of the method of manufacturing a patterned warning mat according to another embodiment of the present disclosure. The method further including step 506 of immersing a mesh layer in the liquid mixture before the mixture solidifies. The mesh layer is a flexible and porous screen having a plurality of pores In one embodiment, the liquid mixture is first poured over the open-face mold to subsequently accumulate in the textures on the open-face mold. However, before the mixture solidifies, the mesh layer is laid over both the open-face mold and the mixture. At this moment, the mixture is still in the liquid state and thus will pass through the pores of the mesh layer to immerse the mesh layer in the process. Tools such as float or margin trowel can be used to evenly distribute and smooth the mixture over the open-face mold and the mesh layer before the mixture solidifies.

In another embodiment, before a liquid mixture is poured over the open-face mold 100, the mesh layer is first laid over the open-face mold. Once the open-face mold is at least substantially covered by the mesh layer, a liquid mixture is poured over at least the part of the mesh layer above the open-face mold. Part of the liquid mixture will pass through the pores of the mesh layer 200 and then accumulate in the patterns of the open-face mold. The liquid mixture eventually immerse the mesh layer. Tools such as float or margin trowel can be used to evenly distribute and smooth the mixture over the open-face mold and the mesh layer before the mixture solidifies.

In the foregoing description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The foregoing detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the

1. A method, comprising:
etching at least one of a plurality of first textures and a plurality of second textures distributed over an open-face mold;
receiving a liquid mixture within the open-face mold that accumulates within the plurality of first textures and the plurality of second textures;
immersing a mesh layer within the liquid mixture; and
allowing the liquid mixture to solidify the plurality of second textures after solidifying the plurality of first textures, and form a warning mat.

2. The method of claim 1, wherein etching at least one of the plurality of first textures and the plurality of second textures comprises etching the plurality of first textures differently than etching the plurality of second textures.

3. The method of claim 1, wherein etching the plurality of first textures comprises injection open-face molding.

4. The method of claim 1, etching the plurality of second textures comprises drilling a predetermined number of openings.

5. The method of claim 1, wherein immersing the mesh layer within the liquid mixture comprises immersing the mesh layer within the liquid mixture based on laying the mesh layer on the open-face mold and the liquid mixture, such that laying the mesh layer on the open-face mold and the liquid mixture immerses the mesh layer in the liquid mixture in response to the liquid mixture passing through pores of the mesh layer.

6. The method of claim 1, wherein immersing the mesh layer within the liquid mixture comprises immersing the mesh layer within the liquid mixture based on pouring the liquid mixture on at least a portion of the mesh layer after laying the mesh layer on the open-face mold.

7. The method of claim 1, wherein allowing the liquid mixture to solidify comprises:
solidifying the plurality of first textures at a first predetermined period of time; and
solidifying the plurality of second textures at a second predetermined period of time.

8. The method of claim 7, wherein the first predetermined period of time is greater than the second predetermined period of time.

9. The method of claim 1, wherein allowing the liquid mixture to solidify is based on ingredients of the liquid mixture.

10. The method of claim 1, wherein receiving the liquid mixture comprises receiving the liquid mixture after mixing at least one of glass beads, sand, and skid resistant material.

11. A method, comprising:
etching at least one of a plurality of first patterns and a plurality of second patterns distributed over an open-face mold;
receiving a liquid mixture through the mesh layer into the open-face mold that accumulates within the plurality of first patterns and the plurality of second patterns;
laying a mesh layer on the open-face mold; and
allowing the liquid mixture to solidify to form a warning mat after the plurality of first patterns and the plurality of second patterns are etched.

12. The method of claim 12, wherein etching the plurality of first patterns comprises etching a plurality of dome indentations based on pressing the open-face mold to form a sunken half-sphere.

13. The method of claim 12, wherein etching each of the plurality of dome indentations comprises etching a plurality of protrusions thereon.

14. The method of claim 12, wherein etching the plurality of second patterns comprises etching a plurality of tiny openings distributed in a diamond shape.

15. The method of claim 12, wherein allowing the liquid mixture to solidify comprises allowing the liquid mixture to dry.

16. The method of claim 12, further comprising:
etching a plurality of third patterns different from the plurality of first patterns and the plurality of second patterns.

17. A warning system, comprising:
a warning mat, comprising:
a base,
a plurality of first patterns extending away from the base with respect to a direction, and
a plurality of second patterns, each of the plurality of second patterns disposed between at least four of the plurality of first patterns; and
a mesh disposed within at least a portion of the base to increase flexibility of the base.

18. The warning system of claim 17, wherein each of the plurality of first patterns comprises:
a dome structure disposed on the base; and. a plurality of protrusions disposed at a center portion of the dome structure.

19. The warning system of claim 17, wherein the mesh disposed within the base prevents the base from breaking down.

20. The warning system of claim 17, wherein each of the plurality of first patterns is disposed on a first surface area of the base and each of the plurality of second patterns is disposed on a second surface area of the base, such that the first surface area is less than the second surface area.
